(19) United States
(12) Patent Application Publication
(10) Pub. No.: US 2009/0240635 A1
(43) Pub. Date: Sep. 24, 2009

(54) Method for discovering new uses of pharmaceutical products through assessment of beneficial side effects in clinical trials

(76) Inventor: Chunlin Qian, Livingston, NJ (US)

Correspondence Address: Chunlin Qian, 42 Irving Ave, Livingston, NJ, 07039, US

(21) Appl. No.: 12/381,983

(22) Filed: Mar. 18, 2009

Related U.S. Application Data
(60) Provisional application No. 61/070,275, filed on Mar. 22, 2008.

(51) Int. Cl. G06Q 90/00

(52) U.S. Cl. 705/500

(57) ABSTRACT

A method for discovering new indications of any pharmaceutical product through systematically assessing the beneficial side effects of it directly from patients and their care takers in clinical trials, without first specifying what those effects might be. One embodiment of the method ensures that all collected beneficial side effects can be coded with a standard dictionary for adverse events, and that all important aspects of them are captured and summarized. The beneficial side effect data collected and analyzed will lead to more and faster discoveries of new indications and better understanding of pharmaceutical products. It is especially promising for diseases that are least understood or least researched. The standard animal-to-human drug research and development model does not work when a drug works in only humans, not animals. Such drugs can, however, be discovered through the method described here.

### CROSS-REFERENCE TO RELATED APPLICATIONS

This application claims the benefit of provisional patent application Ser. No. 61/070,275, filed Mar. 22, 2008 by the present inventor.

### FEDERALLY SPONSORED RESEARCH

Not Applicable

### SEQUENCE LISTING OR PROGRAM

Not Applicable

### BACKGROUND

1. Field

This application relates to clinical trials for pharmaceutical products, such as drugs or medical devices.

2. Prior Art

The federal Food, Drug, and Cosmetics Act of 1938 required the assessment of adverse events, or undesirable side effects, of any pharmaceutical product before it is permitted to be sold to the public. In 1962, through the congressional Kefauver-Harris Amendments, it is further required that the efficacy of any pharmaceutical product be proven before it can be sold to the public. To prove efficacy, clinical trials must be conducted to show that the pharmaceutical product produces the intended pre-specified beneficial effect. These two legislations form the basis for all clinical trials conducted today: prove pre-specified beneficial effects and assess all—pre-specified or not, expected or not—adverse effects.

The beneficial effects of a pharmaceutical product may not be limited to the pre-specified ones in a clinical trial. The beneficial effects that are not pre-specified are called beneficial side effects, or beneficial events (BE), in this application.

Beneficial event data are neither efficacy nor safety data. As a result, they have not been required to be systematically assessed in clinical trials. Currently beneficial event data are obtained mainly through the following means:
1) Anecdotal stories. Viagra for erectile dysfunction was discovered this way. Another example is Zyban for smoking cessation, which was discovered while depression studies were conducted on Wellbutrin, which is the same drug as Zyban.
   Disadvantages: There are anecdotal stories of beneficial side effects in many clinical trials, but they are usually ignored because, unless the effects are very striking to the observer, who then makes a major effort to pursue it, there is no further data collection or analyses. It can take many years for such anecdotal stories to finally gain enough mass for any research effort, if ever.
2) Unexpected findings in adverse event data. The drug Propecia came out in the 1980's as a treatment for the enlarged prostate. Adverse event data showed that some patients had hair growth after taking Propecia. Someone finally realized that this might be of benefit to some people, and it became a remedy for hair loss since the mid-1990's. Another possibility is through summary adverse event data. When summary adverse event data show that the number of patients reporting a particular adverse event is smaller for those taking a drug than those taking a placebo, some investigators may be interested to know if the drug prevents such an event from happening.
   Disadvantages: For a new indication to be discovered in the Propecia way, the side effect has to be adverse to some patients while beneficial to others. Clear cut improvements of pre-existing conditions are in general not considered adverse events, which are defined as the worsening of pre-existing conditions, among other things. When summary adverse event data show some prevention potential, it is natural to think if there is also treatment potential. But preventing a disease from happening is not exactly the same as treating such a disease. Only beneficial event data can assess treatment potential directly.
3) Unexpected findings in other safety data such as vital signs and laboratory tests. Vital signs data have been a good source in discovering drugs that also result in weight loss as a side effect. Welchol for diabetes was discovered after laboratory data from cholesterol studies indicated that it reduced glucose level as a side effect.
   Disadvantages: There are only several vital signs and at most a few dozen laboratory test variables in a typical clinical trial. Possible findings of beneficial events through this means are limited. There must be thousands of possible diseases, conditions, or symptoms that need treatment, and very few of them can be determined properly through vital signs data or standard laboratory tests typically conducted in a clinical trial.
4) New scientific theory leads to new experiments of existing drugs. When a new scientific theory in medicine is proposed, pre-clinical scientists tend to screen existing drugs to see if such a drug could have the desired effect based on the new theory. Aspirin is a classical example here. It was initially developed about a hundred years ago for aches and pains. Now it is also taken by many people to prevent heart diseases. Scientists are still looking for new mechanisms of action for Aspirin.
   Disadvantages: By the time such screening is conducted, the drug may have been on the market for a long time. Most pharmaceutical companies get most of their revenue from new drugs under the protection of patents or exclusivity. Once a drug has generic competition or close to patent/exclusivity expiration, there is little financial incentive to develop a new indication for the drug. What happens sometimes is that, instead of developing the drug for a potential new indication directly, a similar but new chemical entity gets developed to achieve the same effect. This can take many years.

Due to the disadvantages of existing means, a better way to systematically assess beneficial events at the earliest possible time is called for. This application is exactly for such a purpose. The implementation of the method described in this application will result in more new indications to be pursued by various pharmaceutical companies at an earlier time than is possible through existing means. Investigators can also implement the method independent of any pharmaceutical company for the purpose of obtaining new use patents of existing drugs. One pharmaceutical company can also use the collected beneficial event data to apply for new use patents of products belonging to other pharmaceutical companies. Beneficial event data will also inspire basic research scientists to work in new directions.

### SUMMARY

The application is for an easy to implement method for discovering new uses of pharmaceutical products by systematically assessing their beneficial side effects in clinical trials directly from patients and their care takers, without first specifying what those beneficial side effects might be. Other publishable useful information may also be obtained through such a method.

### DRAWINGS—FIGURES

Not Applicable

### DETAILED DESCRIPTION

To systematically assess beneficial side effects in clinical trials, four templates are provided in this application. Together, they provide sufficiently detailed steps for the implementation of the method.
I: Template for Beneficial Event Case Report Form
II: Template for Beneficial Event Case Report Form Completion Guidance
III: Template for Beneficial Event Database Structure
IV: Template for Summarizing Beneficial Event Data

Templates I and II are for data collection. Here a beneficial event (BE) is defined as the improvement of a pre-existing disease, condition, or symptom and is collected as such. This ensures that the collected BE is clinically relevant, and, just as importantly, a well developed coding dictionary for diseases/conditions/symptoms such as the widely used MedDRA can be used to code all BE. This will make the summarization and analyses of BE simple. There would be no need to develop a new coding dictionary specifically for BE data. The BE case report form collects the most important aspects of any BE in a uniform manner, enabling high quality data collection without unnecessary noise. It is virtually impossible for any adverse event to be reported on the BE form, which can be very important from a regulatory perspective.

Data collection can be through either paper or electronic means. The described Templates I and II can be readily incorporated into clinical trials using paper case report forms. It takes just a little more effort to adapt these templates into clinical trials using electronic data capture.

Template III provides specifications for the BE database structure. This enables the uniform conversion of case report form data to a format that can be used by statisticians and programmers for analyses.

Template IV provides specifications for data summarization, enabling the uniform assessment of all important signals. When BE data are summarized in such a way, even a small number of BE reports can provide convincing evidence for a potential new indication.

### Template I: Beneficial Event Case Report Form

A beneficial event is the improvement of a pre-existing disease, condition, or symptom different from the intended efficacy.

Use Improvement Scale: (0) none, (1) minor, (2) medium, (3) major, (4) complete Always compare to the pre-existing status before the start of study treatment.

Initial Report

(R0) On ______, a (circle one) (1) (2) (3) (4) improvement of ______ was first noticed.

Changes from Initial Report to End of Treatment (if any)
(R1) On ______, the improvement changes to (circle one) (0) (1) (2) (3) (4) when the treatment was (circle one) (a) interrupted (b) not interrupted

[Follow (R1) with (R2), (R3), and (R4) in the same format. For electronic case report form, use subform.]

Status at the End of Treatment

(R5) On the last day of treatment, the improvement is (circle one) (0) (1) (2) (3) (4). Over the course of the study, the beneficial event was noticed/confirmed by (circle all that apply)
A. patient/family B. physician/nurse C. medical tests D. other

Status Following the End of Treatment (R6 is required but R7 is optional)

(R6) On ______, the improvement is (circle one) (0) (1) (2) (3) (4)

(R7) On ______, the improvement changes to (circle one) (0) (1) (2) (3) (4)

### Template II: Beneficial Event Case Report Form Completion Guidance

While a beneficial event (BE) can be any desirable side effect, only those that can be reported as the improvement of a pre-existing disease, condition, or symptom are collected here. Most desirable side effects can be reported in such a way (see examples for Initial Report below).

A BE may be volunteered spontaneously by the patient, may be discovered as a result of general questioning by the investigator, or may be detected by physical examination or medical tests.

This is a ‘summary page’ that should be updated whenever substantial new information is available for the initially reported BE throughout the trial, as well as afterwards.

The Improvement Scale is always for comparisons to the pre-existing status before the initiation of study treatment, from the initial report R0 to the last report R7. The 5-point scale is meant to be anchored at two ends by 0 (for no improvement, same as pre-existing state) and 4 (complete improvement to desired/normal state). The three numbers in the middle each cover about a third of the difference between complete improvement and no improvement (please use best judgment for individual cases):

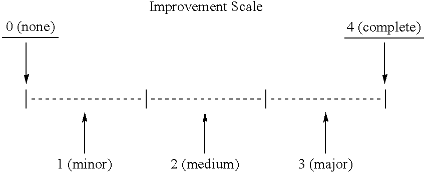

No code for worsening is included here because this is a BE form, not an AE form. All adverse events MUST BE reported on the AE form, not on this BE form.

Initial Report (R0)

The initial report has to be at least a ‘(1) minor’ improvement. The format is to ensure that only the improvement of a pre-existing disease/condition/symptom is reported. This may be different from the initial language used, therefore certain efforts, including further inquiry, are needed to translate the initial language. Examples (only the underlined words should be entered for pre-existing disease/condition/symptom):
1) A patient initially reports ‘hair growth’ as something he considers beneficial. This needs to be translated into the improvement of ‘hair loss’ or ‘baldness’ or something else depending on the individual case.
2) A patient initially reports ‘better sex’. This needs to be translated into the improvement of ‘erectile dysfunction’ or ‘low libido’ or something else that specifically fits the individual situation.
3) A patient initially reports ‘better sleep’. This needs to be translated into the improvement of ‘insomnia’ or ‘back pain’ or something else that best describes the situation.

It should be more straightforward when the improvement is for clear pre-existing diagnoses such as migraine, psoriasis, acne, Alzheimer's disease, and etc. Try to use standard medical terminology for the pre-existing diseases, conditions, or symptoms.

If there are improvements of multiple pre-existing diseases/conditions/symptoms, please report them separately using multiple BE pages.

Changes from Initial Report to End of Treatment (R1-4) (if any)

This part is optional. It is to be used only when the improvement changed at least by 1 on the Improvement Scale from the previous report (R1 compared to R0, R2 compared to R1, and so on). For instance, if after the initial reporting of ‘(1) minor’ improvement of acne, there is continuous improvement to ‘(2) medium’, ‘(3) major’ and ‘(4) complete’, (R1), (R2) and (R3) should be used.

It is also important to report the reversing of the initially reported improvement, especially after treatment interruption, as this is strong evidence for causal relationship.

There is no need to go beyond R4 for this part.

Status at the End of Treatment (R5)

This describes the status on the last day of treatment and it should be filled out for every reported BE.

Circle all applicable sources of information for the report of the BE over the course of the study. This may help in showing how credible the BE report is.

Status Following the End of Treatment (R6 and R7)

[It is assumed here that, at the end of treatment, patients no longer take any study drug, or they may switch to a different drug. If it is clear by the design of the protocol that, at the end of treatment, patients go to the next phase of the study but continue to take the same drug, then the next phase should be considered part of the initial study for the purposes of BE reporting, even though other data may not be considered this way.]

R6 is required except perhaps for the last few patients when such data collection would delay the close-out of the study. [The timing of the R6 report needs to be determined in the protocol. It is a time that one would reasonably expect that withdrawal effect should have occurred if there is such an effect.]

R7 is optional. It is to be used only when the improvement changed at least by 1 from the R6 report on the Improvement Scale.

### Template III: Beneficial Event Database Structure

The raw database should at least contain the following variables. Note that the MedDRA dictionary is used in the raw database to code the pre-existing disease/condition/symptom into primary system organ class and preferred term, which will make the summarization of beneficial events simple.

The dataset contains one record per PID DCS RPTN.

| Variable | Label | Values | Comment |
|---|---|---|---|
| STUDY | Study Number | standard study | |
| | | number | |
| PID | Patient ID | standard ID | Usually consists of site and patient |
| | | | numbers |
| RPTN | Report Number | R0, R1, . . . , R7 | |
| EVTD | Event Date | SAS date | Corresponds to the RPTN |
| DCS | Pre-existing | free text | Exists only for RPTN = ’R0’, to be |
| | Dis/Cond/Symp | | coded using MedDRA |
| PSOC | Primary System | MedDRA | Coded for DCS using MedDRA |
| | Organ Class | PSOC | |
| PT | Preferred Term | MedDRA | Coded for DCS using MedDRA |
| | | preferred term | |
| IMPS | Improvement | 0, 1, 2, 3, 4 | Format: 0 = ’none’, 1 = ’minor’, |
| | Scale | | 2 = ’medium’, 3 = ’major’, |
| | | | 4 = ’complete’ |
| PERTEST | Person or Test | A, B, C, D | Format: A = ’patient/family’, |
| | Reporting or | | B = ’physician/nurse’, C = ’medical |
| | Confirming | | tests’, D = ’other’ |
| INTRPT | Treatment | a, b | Format: a = ’interrupted’, |
| | Interruption | | b = ’not interrupted’ |

### Template IV: Summarizing Beneficial Event Data

Data from the beneficial event (BE) raw database combined with other regular data from the same clinical trial can be summarized to show treatment differences in the following parameters.
1) Number of patients reporting the improvement of a particular pre-existing disease/condition/symptom using coded Primary System Organ Class and Preferred Term. (Numeric evidence.)
2) The time from treatment initiation to first reporting. (Initial effect speed.)
3) The maximum improvement ever reported. (Maximum effect.)
4) The time from treatment initiation to maximum improvement. (Maximum effect speed.)
5) Whether any improvement reversed course following treatment withdrawal. (Causal relation evidence.)
6) How many parties/methods noticed/confirmed the BE. (Credibility evidence.)

For a clinical trial with two treatments (say, Active and Control), the following table shell can be used. (Just add more columns for more treatment groups. The Primary System Organ Class is not used in the following table shell but can be easily added if necessary.)

### Summary of Reported Improvements of Pre-existing Diseases, Conditions, or Symptoms, By Preferred Term and Treatment

| Preferred Term (improved) | Active | Control |
|---|---|---|
| Psoriasis | | |
| Number of patients reporting the BE | 10 | 5 |
| Days to 1^{st} reporting, mean (SD) | 10 (9) | 25 (30) |
| Maximum improvement, mean | 3.1 | 1.4 |
| Days to maximum improvement, | 35 (12) | 39 (38) |
| mean (SD) | | |
| Effect reversing due to treatment | 8 | 1 |
| withdrawal | | |
| Reported/confirmed by: | | |
| Patient/family | 10 | 3 |
| Physician/nurse | 9 | 3 |
| Medical tests | 8 | 1 |
| Other | 3 | 0 |
| Migraine | | |
| Number of patients reporting the BE | | |
| . . . | | |

### CONCLUSION, RAMIFICATIONS, AND SCOPE

There is a vast amount of medical literature suggesting or proving new indications of existing drugs, but it is rare that such new indications are found early during the drug development phase. One important reason new indications are not found early is that the improvements of pre-existing conditions (different from the main condition targeted for efficacy) are not collected in clinical trials. The systematic collection of such data will uncover many unexpected benefits that are only discovered much too late with existing means, if at all. Such a method is especially useful for the least-understood diseases such as multiple sclerosis and Alzheimer's, or diseases mainly prevalent in developing countries now that more and more clinical trials are done there.

The standard way of drug research and development is from animals to humans. This works only when a drug works in both animals and humans. It cannot work if a drug only works in humans, not in animals. The method described in this application is useful in discovering such drugs that only work in humans. Just as many drugs that work in animals do not work in humans, there must be many drugs that work for humans but not for animals.

The templates described above can be easily implemented by any clinical trial team, or even just an independent investigator within the team. With some modification, such method can also be used in post-marketing surveillance to gather beneficial side effects of marketed pharmaceutical products.

Aside from revealing possible new indications, beneficial event data may also reveal other important information worth publication. Not all new information needs to a new indication. It could simply show an advantage of one drug over another. It could also inspire a curious scientist to look at things in a new way. As the saying goes, “observation brings inspiration”.

Although the descriptions above contain many specifics, these should not be construed as limiting the scope of the embodiments but as merely providing illustrations of some of the presently preferred embodiments. For example, instead of the filling-the-blanks approach in Template I, one can ask such questions as “What pre-existing condition was improved?” “Was treatment interrupted? Circle yes or no.” The 5-point scale for improvement is but one of many possibilities. Thus the scope of the embodiments should be determined by the appended claims and their legal equivalents, rather than by the examples given.

I claim:

1. A method for discovering new indications of any pharmaceutical product through systematically assessing the beneficial side effects of the product directly from patients and their care takers, without first specifying what those beneficial side effects might be.

2. The method of claim 1 wherein the said beneficial side effect is collected as the improvement of something adverse for the said patient that existed before being treated with the said pharmaceutical product.

3. The method of claim 2 wherein the said improvement is grouped into a plurality of categories covering different degrees of improvement.

4. The method of claim 2 wherein the changes of the said improvement after the initial reporting are captured.

5. The method of claim 2 wherein the categories of people who reported the said improvement are recorded.

6. The method of claim 2 wherein the date of the said improvement is collected.

7. The method of claim 2 wherein the date of any meaningful change of the said improvement is collected.

8. The method of claim 2 wherein whether a patient is on or off treatment with the said pharmaceutical product while the said improvement occurred is recorded.

9. The method of claim 2 wherein whether a patient is on or off treatment with the said pharmaceutical product while any meaningful change to the said improvement occurred is recorded.

10. The method of claim 2 wherein the said something adverse is coded into standard terms using an existing dictionary for adverse events.

11. The method of claim 1 wherein the said beneficial side effects in one or more clinical trials are summarized into a table showing numbers grouped by the treatment of the said pharmaceutical product the patient received.

12. The method of claim 11 wherein the said table shows the number of patients reporting the said beneficial side effect.

13. The method of claim 11 wherein the said table shows the average number of days from first using the said pharmaceutical product to the first report of the said beneficial side effect.

14. The method of claim 11 wherein the said table shows the average maximum degree of the said beneficial side effect.

15. The method of claim 11 wherein the said table shows the average number of days from first using the said pharmaceutical product to the reporting of the said beneficial side effect of the maximum degree.

16. The method of claim 11 wherein the said table shows the number of patients reporting reversing of the said beneficial side effect due to interruption or withdrawal of the said pharmaceutical product.

17. The method of claim 11 wherein the said table shows the different categories of people who reported or confirmed the said beneficial side effect.

18. A method for discovering the unexpected effects of any pharmaceutical product in humans by systematically and directly asking the consumers of the product and their care takers with an open-ended question whether they noticed any unexpected improvement in a pre-existing medical condition not intended to be treated by the product.
